(19) United States
(12) Patent Application Publication
(10) Pub. No.: US 2015/0302718 A1
(43) Pub. Date: Oct. 22, 2015

(54) SYSTEMS AND METHODS FOR INTERPRETING DRIVER PHYSIOLOGICAL DATA BASED ON VEHICLE EVENTS

(71) Applicant: GM GLOBAL TECHNOLOGY OPERATIONS LLC, Detroit, MI (US)

(72) Inventor: AMIR KONIGSBERG, HERZLIYA PITUACH (IL)

(73) Assignee: GM GLOBAL TECHNOLOGY OPERATIONS LLC, Detroit, MI (US)

(21) Appl. No.: 14/258,453

(22) Filed: Apr. 22, 2014

(51) Int. Cl. G08B 21/04

(52) U.S. Cl. CPC G08B 21/04

(57) ABSTRACT

A method for interpreting physiological information includes receiving, from at least one physiological signal source, physiological data associated with a user of a vehicle, receiving vehicle event data and driving context data associated with operation of the vehicle, and determining a state of the user based on the vehicle event data, the driving context data, and the physiological data.

### TECHNICAL FIELD

The technical field generally relates to vehicle-based human-machine interface (HMI) systems, and more particularly relates to systems and methods for correlating physiological signals with vehicle-related events in the context of such systems.

### BACKGROUND

Modern vehicles, particularly automobiles, are increasingly capable of sensing and monitoring the physiological activity (heart rate, facial expression, eye movement, etc.) of its passengers using a variety of non-invasive devices. Such devices include, for example, sensors incorporated into the vehicle interior, sensors present within mobile devices, sensors embedded within wearable technology, and the like. The resulting physiological data may be used for a variety of purposes, including detecting the emotional state, cognitive state, or the alertness of the driver.

Currently known systems and methods for interpreting such physiological data may not be ideal in a number of respects, however. For example, the data itself may be ambiguous, unclear, noisy, and/or fairly generic, and thus may not be optimal for certain vehicle environments. Furthermore, the quality of such data may result in driver-state misdetection (states not detected when they do occur) or false alarms (states detected when they are not actually present).

Accordingly, it is desirable to provide improved systems and methods for determining the state of a user (e.g., the driver) of a vehicle using physiological data. Furthermore, other desirable features and characteristics of the present invention will become apparent from the subsequent detailed description and the appended claims, taken in conjunction with the accompanying drawings and the foregoing technical field and background.

### SUMMARY

A method for interpreting physiological information in accordance with one embodiment includes receiving, from at least one physiological signal source, physiological data associated with a user of a vehicle, receiving vehicle event data associated with operation of the vehicle, receiving data associated with the driving situation or context (e.g., traffic, road conditions), and determining a state of the user based on the vehicle event data and the physiological data.

In accordance with another embodiment, a vehicle-based physiological interpretation system comprises a physiological interpretation module and an action determination module. The physiological interpretation module is configured to receive physiological data associated with a user of the vehicle, receive vehicle event data associated with operation of the vehicle, receive data relating to the driving situation, and determine a state of the user based on the vehicle event data, driving situation data, and the physiological data. The action determination module is configured to receive, from the physiological interpretation module, the state of the user, and to determine a suggested action based on the state of the user.

### DESCRIPTION OF THE DRAWINGS

The exemplary embodiments will hereinafter be described in conjunction with the following drawing figures, wherein like numerals denote like elements, and wherein:

FIG. 1 is a conceptual overview of a vehicle-based system in accordance with various exemplary embodiments.

FIG. 2 is a flow chart depicting a method in accordance with an exemplary embodiment.

### DETAILED DESCRIPTION

The subject matter described herein generally relates to the use and aligning of driving event data with physiological data available for the user of a vehicle. In this way, the state of the user (e.g., the driver) can more accurately be determined and acted upon. In this regard, the following detailed description is merely exemplary in nature and is not intended to limit the application and uses. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

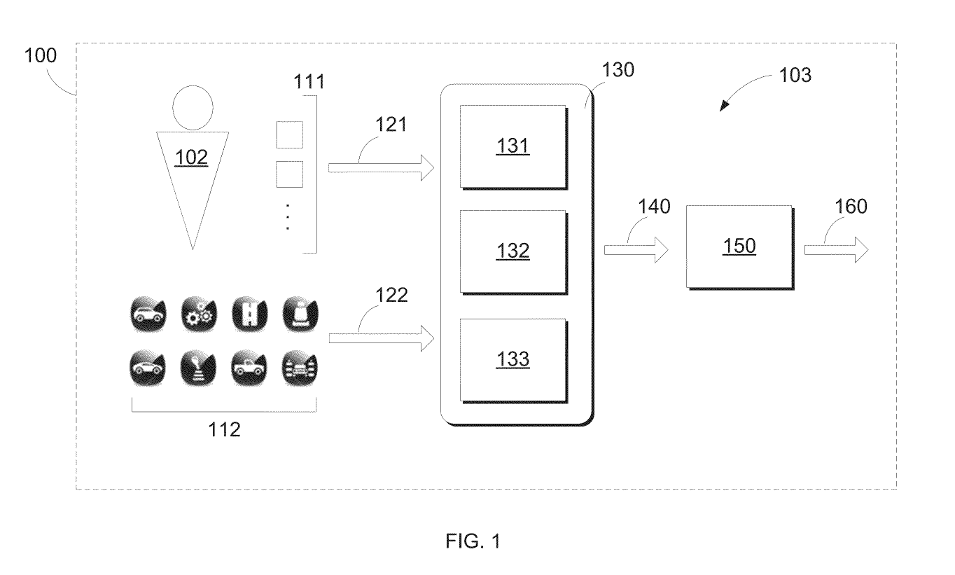

Referring now to the conceptual diagram shown in FIG. 1, in accordance with exemplary embodiments of the subject matter described herein a vehicle-based physiological interpretation system (or simply “system”) 103 is configured, in general, to receive physiological data 121 associated with a user 102 (e.g., a passenger) of vehicle 100 along with vehicle event data 122 associated with operation of vehicle 100. Physiological data 121 may be generated, collected, or otherwise provided by one or more physiological signal sources 111 (described in further detail below). The vehicle event data 122 includes information corresponding to a variety of vehicle events or states. In particular, “vehicle events” are events that either happen in or relate to the systems of the vehicle, and “driving events” relate to the driving context—i.e., outside the vehicle. Without loss of generality, these events are conceptually illustrated as events 112 and may be referred to herein as simply “vehicle events.” System 103 is further configured to determine a state 140 of the user (e.g., “sleepy”, “agitated”, etc.) based on the vehicle event data 122 and the physiological data 121. System 103 may also include an action determination module 150 configured to receive, from physiological interpretation module 130, the state 140 of the user, and to determine a suggested action 160 based on the state of the user.

Although not illustrated in FIG. 1, it will be understood that vehicle 100 might also include various additional components that, in the interest of simplicity, are not illustrated in the figure—e.g., one or more in-vehicle, integrated displays and user interface device typically used in connection with a navigation system, a climate control system, a vehicle infotainment system, and/or the like.

Physiological signal sources 111 may include any combination of hardware and software capable of sensing and monitoring some physiological activity of the driver and/or other passengers. Such sources 111 may include a variety of non-invasive devices known in the art, such as sensors incorporated into the vehicle interior (e.g., the driver's seat, the steering wheel, the rear-view mirror, etc.), sensors present within mobile devices, sensors embedded within wearable technology (wrist-worn health monitors, smart eye-ware, etc.) and other such sensors.

One or more mobile devices (some wearable, some simply carried) might incorporate physiological sensors 111 and may be present within the interior of vehicle 100, including, for example, one or more smart-phones, tablets, laptops, feature phones, wearable devices, or other the like. Such mobile devices may be communicatively coupled to module 130 through one or more intervening modules, processors, etc. (not illustrated), and via a suitable wireless data connection, such as Bluetooth or WiFi.

Regardless of the particular signal sources 111 available in a given vehicle, the sensed physiological data may include a wide range of data types, including, for example, heart-rate, EEG data, oxygen use, eye motion, galvanic skin response, blood flow, pupil dilation, GSR, and other such data.

Vehicle-related events 112 may include any of the variety of events and states of a vehicle as determined through the available data sources typically incorporated into vehicle 100. Vehicle-related events 112 are not limited to attributes of the vehicle itself, but also extend to events and states relating to the environment in which vehicle 100 is being operated. That is, while events 112 might typically include states associated with vehicle 100 (such as position, velocity, braking, acceleration, heading, lane changes, presence of passengers, such as kids, in the vehicle), they would also include events relating to traffic (“congested”, “clear”, etc.) and environment (“rain”, “snow”, “sunny”, “night-time”, “day-time”, “dusk”, etc.). Vehicle events 112 may each be given an “event code” (having any suitable format) and is communicated as vehicle-related event data 122 accompanied by a time-stamp corresponding to the time that the event occurred. Examples of vehicle events include traffic, weather, visibility, road conditions, accidents, traffic alerts, distance-from-other vehicles (congestion ratio). Other events include actions being executed by the driver or other drivers—e.g., overtaking, speeding, breaking, lane transitions, parking, aggressive driving, slow driving. As described herein, such events can be aligned to particularly physiological data of the driver and/or passenger.

Vehicle-related events 112 may be determined and communicated through external sources (cloud-data, inter-vehicle communication) as well as sources internal to vehicle 100 itself (e.g., the vehicle's controller-area network).

Module 130 includes any suitable combination of hardware and software capable of utilizing vehicle event data 122 and physiological data 121 to determine user state 140. In accordance with various embodiments, determining the state 140 of user 102 includes providing a machine learning model configured to correlate the vehicle event data with the physiological data associated with the user. In one embodiment, for example, module 130 includes a feature extraction module 131, a machine learning module 132, and an analysis module 133.

Feature extraction module 131 is configured to receive physiological data 121 and extract a set of features in connection with the training that is performed by machine learning module 132. That is, machine learning module 132 will typically have been trained (via supervised or unsupervised learning) using certain features found to provide a suitable level of prediction. A variety of known machine learning models may be employed, including, for example, cluster analysis (K-nearest neighbor, support vector machine (SVM), and the like) and/or various classification techniques that may assist in “labeling” the physiological data utilizing the vehicle-related event data. Accordingly, analysis module 133 may then use the results produced by machine learning module 132 to determine the most likely user state 140. That is, at any given time the physiological data 12 may be “unlabeled” in that it is not correlated to a particular user state. Module 130 thus determines the most likely user state label (either in real-time, or not in real-time) using available information—some of which may be stored remotely on a server and may include crowdsourced data associated with other users that exhibit similar behavior (e.g., the same general correspondence of vehicle-related data to physiological data).

User state 140 may take a variety of forms and may represent a range of possible user states. In some embodiments, for example, possible user states include a state corresponding to a level of user drowsiness (e.g., ranging from “alert” to “sleepy”), a state corresponding to a level of user stress (e.g., ranging from “calm” to “agitated”), a level of fear of the user, a state correlated to the event of overtaking another driver, and a state correlating to the event of being overtaken by another driver.

Suggested action 160 may also take a variety of forms, and may represent a wide range of potential actions to be taken based on the state 140 of the user. For example, in some embodiments the suggested action includes a notification to the user (e.g., audio and/or visual notification) recommending to user 102 a particular action (e.g., “please slow down”, etc.) viewable on an in-vehicle display. In some embodiments, suggested action 160 includes providing an instruction configured to alter operation of the vehicle 100 (e.g., application of brakes, etc.). In another embodiment, the suggested action includes the automatic adaptation of vehicle systems to the state of the user. Such adaptation may involve the infotainment system (e.g., visual clutter reduction upon the detection of a state of cognitive overloading, or playing calming music upon the detection of user anxiety). Similarly, adaptation can involve vehicle systems that upon detection of potentially dangerous user states such as fatigue, distraction, overload, can mitigate risk by correcting or overtaking control of the vehicle (e.g., by automatic driving capabilities).

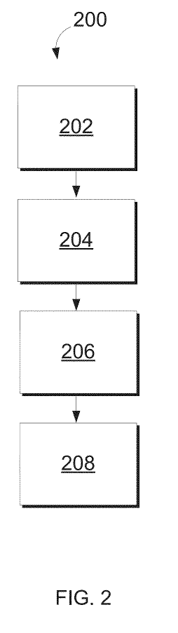

Having thus described a physiological detection system in accordance with one embodiment, FIG. 2 depicts a physiological state detection method 200 that might be used in connection with such a system. First, as detailed above, the method includes receiving physiological data associated with a user of a vehicle is that is received from at least one physiological signal source present within the vehicle (202). Similarly (e.g., at substantially the same time), vehicle event data associated with operation of the vehicle is received (204). Based on the vehicle event data and the physiological data, a user state is then determined (206). Determining the state of the user may include providing a machine learning model (e.g., a model trained via any suitable supervised or unsupervised training technique known in the art) configured to correlate the vehicle event data with the physiological data associated with the user. A suggested action based on the state of the user may then be determined (208). In one embodiment, the suggested action may include at least one of providing a notification to the user and providing an instruction configured to alter operation of the vehicle.

Many example use-cases may be contemplated for a system as described above. In accordance with one example, the system may determine that the user often becomes angry or nervous (i.e., user state labeled as “agitated”) when in heavy traffic. The system may then suggest to the user that the channel on the audio system be changed to provide relatively soothing music. Conversely, in accordance with another example the system may recommend that more energetic music be played to counteract perceived sleepiness of the user. In another example, the system may determine that the suddenness of a particular upcoming blind curve (known via the position of the user and crowdsourced data relating to similarly situated users) is likely to frighten the user, and may thus notify the user that a speed reduction might be appropriate. In accordance with another example, the system may form a hypothesis about what state the user is in and the system might presume this hypothesis to be true by varying degrees—i.e., more or less—depending on how many instances it has seen, the quality of the data received, the reliability of the data, etc. Once the system forms a hypotheses, it can improve its certainty regarding the hypothesis by asking the user whether he or she is indeed in the state presumed by the system. This may be referred to as a “labeling” solution.

In summary, what has been described are various systems and methods for using vehicle-related event data in conjunction with physiological data to arrive at a more accurate predictions of the user's state. In this way, the resulting user state information is more useful in the context of vehicle operation, and may be used to adaptively react based on the signals that are detected.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for interpreting physiological information comprising:
receiving, from at least one physiological signal source, physiological data associated with a user of a vehicle;
receiving vehicle event data associated with operation of the vehicle;
receiving driving context data associated with the context in which the vehicle is operation; and
determining a state of the user based on the vehicle event data, the driving context data, and the physiological data.

2. The method of claim 1, further including determining a suggested action based on the state of the user.

3. The method of claim 1, wherein the suggested action comprises at least one of providing a notification to the user and providing an instruction configured to alter operation of the vehicle.

4. The method of claim 1, wherein determining a state of the user includes providing a machine learning model configured to correlate the vehicle event data with the physiological data associated with the user.

5. The method of claim 1, wherein the state of the user includes at least one state corresponding to a level of user drowsiness and a second state corresponding to a level of user stress.

6. The method of claim 1, wherein the vehicle event data includes at least an event code and a time-stamp corresponding to the time that a vehicle event occurred.

7. The method of claim 1, wherein the at least one physiological signal source is configured to measure at least one of heart-rate, oxygen use, eye motion, perspiration and level.

8. A vehicle-based physiological interpretation system comprising:
a physiological interpretation module configured to receive physiological data associated with a user of the vehicle, received vehicle event data associated with operation of the vehicle, and determine a state of the user based on the vehicle event data and the physiological data; and
an action determination module configured to receive, from the physiological interpretation module, the state of the user, and to determine a suggested action based on the state of the user.

9. The system of claim 8, wherein the suggested action comprises at least one of providing a notification to the user and providing an instruction configured to alter operation of the vehicle.

10. The system of claim 8, wherein determining the state of the user includes providing a machine learning model configured to correlate the vehicle event data with the physiological data associated with the user.

11. The system of claim 8, wherein the state of the user includes at least one state corresponding to a level of user drowsiness and a second state corresponding to a level of user stress.

12. The system of claim 8, wherein the vehicle event data includes at least an event code and a time-stamp corresponding to the time that a vehicle event occurred.

13. The system of claim 8, wherein the physiological interpretation module includes a feature-extraction module configured to interpret the physiological data, a machine learning module, and an analysis module configured to determine the state of the user.

14. The system of claim 8, wherein the at least one physiological signal source is configured to measure at least one of heart-rate, oxygen use, eye motion, perspiration and level.

15. Non-transitory computer-readable media bearing software instructions configured to instruct a processor to perform the steps of:
receiving, from at least one physiological signal source, physiological data associated with a user of a vehicle;
receiving vehicle event data associated with operation of the vehicle; and
determining a state of the user based on the vehicle event data and the physiological data.

16. The non-transitory computer-readable media of claim 15, wherein the software instructions are further configured to determine a suggested action based on the state of the user.

17. The non-transitory computer-readable media of claim 15, wherein the suggested action comprises at least one of providing a notification to the user and providing an instruction configured to alter operation of the vehicle.

18. The non-transitory computer-readable media of claim 15, wherein determining a state of the user includes providing a machine learning model configured to correlate the vehicle event data with the physiological data associated with the user.

19. The non-transitory computer-readable media of claim 15, wherein the software instructions are further configured to, wherein the state of the user includes at least one state corresponding to a level of user drowsiness and a second state corresponding to a level of user stress.

20. The non-transitory computer-readable media of claim 15, wherein the vehicle event data includes at least an event code and a time-stamp corresponding to the time that a vehicle event occurred.
